(19) United States
(12) Patent Application Publication
(10) Pub. No.: US 2005/0117459 A1
(43) Pub. Date: Jun. 2, 2005

(54) Multifunction DVD expansion playback device

(76) Inventor: Shien Lung Fan, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/724,140

(22) Filed: Dec. 1, 2003

(51) Int. Cl. H04B 1/20

(52) U.S. Cl. 369/2; 369/6

(57) ABSTRACT

A multifunction digital versatile disc (DVD) expansion playback device combines a portable DVD player and a fixing base having functions of a peripheral together. The power of the DVD player comes from an external direct current (DC) power so that the DVD player can be used indoors, outdoors or in a car. Signals of the peripheral are received from the DVD player. The DVD player can also be taken out from the fixing base.

### FIELD OF THE INVENTION

The present invention relates to a multifunction digital versatile disk (DVD) expansion playback device and, more particularly, to a device, which combines a portable DVD player and a fixing base having the functions of a peripheral together.

### BACKGROUND OF THE INVENTION

A common portable DVD player can perform read, playback or access of audio/video data. A car ceiling DVD player has the same functions and is fixed in a car, but can't be taken out for use.

If a consumer wants to simultaneously have the functions of a portable DVD player and a car ceiling DVD player, he has to pay more money.

Accordingly, if the functions of a portable DVD player and a car ceiling DVD player can be integrated together, the expense can be greatly reduced.

### SUMMARY OF THE INVENTION

One object of the present invention is to provide a multifunction DVD expansion playback device connected with the car electric power and a peripheral, whereby a portable DVD player can be combined in a car.

Another object of the present invention is to provide a multifunction DVD expansion playback device, which is applicable indoors and outdoors.

Yet another object of the present invention is to provide a multifunction DVD expansion playback device capable of lowering the cost.

To achieve the above objects, the present invention provides a multifunction DVD expansion playback device, which combines a fixing base having the functions of a peripheral and a portable DVD player together.

When the DVD player and the fixing base are combined together, signals of the peripheral are received from the DVD player. The DVD player can also be taken out from the fixing base.

The above peripheral can be an assembly of amplitude modulator (AM), frequency modulation (FM) or car audio loudspeakers.

The power of the above DVD player comes from the car electric power or an external direct current (DC) power.

The above DVD player can be combined with the fixing base by means of embedding, slide grooves, rollers or slide tracks.

The various objects and advantages of the present invention will be more readily understood from the following detailed description when read in conjunction with the appended drawing, in which:

### BRIEF DESCRIPTION OF THE DRAWINGS

FIG. 1 is an exploded perspective view according to an embodiment of the present invention;

FIG. 2 is an assembly view of FIG. 1;

FIG. 3 is an exploded perspective view according to another embodiment of the present invention;

FIG. 4 is an exploded perspective view according to yet another embodiment of the present invention;

FIG. 5 is a diagram showing the present invention is assembled in a car;

FIG. 6 is a diagram showing the connection between the embodiment shown in FIG. 1 and the peripheral;

FIG. 7 is a diagram showing the connection between the embodiment shown in FIG. 4 and the peripheral;

FIG. 8 is a diagram showing the present invention is applied indoors;

### DETAILED DESCRIPTION OF THE PREFERRED EMBODIMENTS

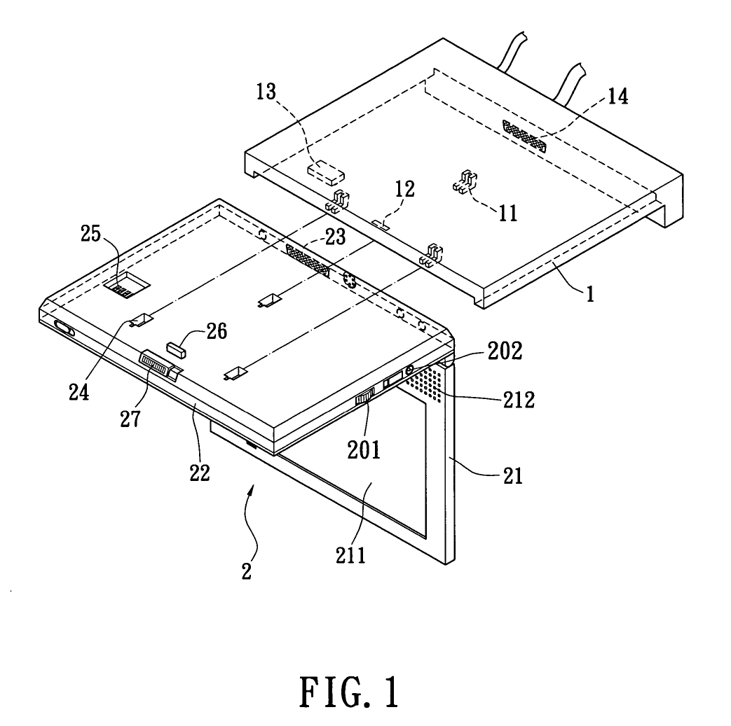

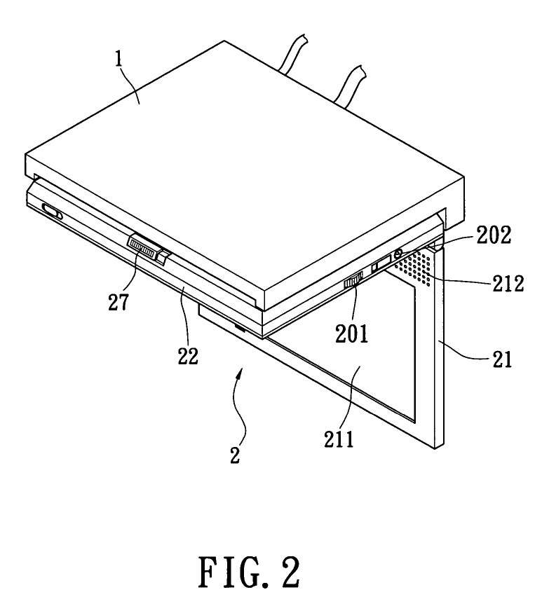

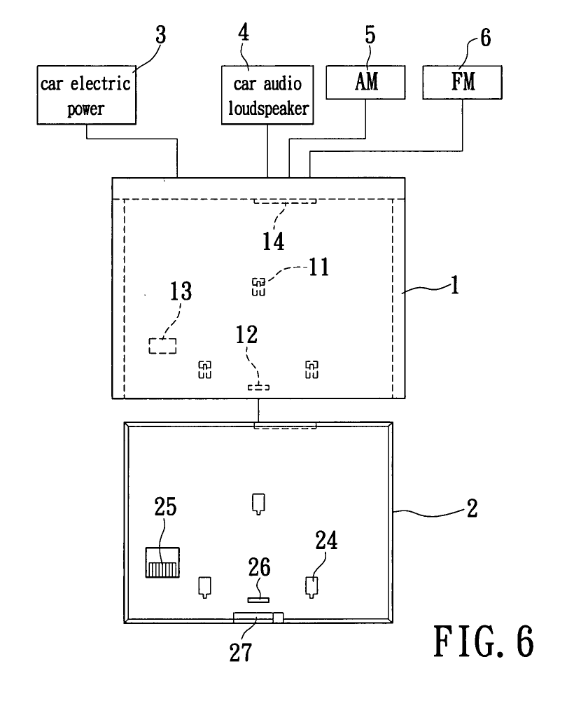

As shown in FIGS. 1, 2 and 6, a multifunction DVD expansion playback device of the present invention comprises a fixing base 1 having functions of a peripheral and a portable DVD player 2.

The fixing base 1 is slightly L-shaped, and is disposed in a car. Several (three) barbs 11 and a power connection portion 13 of the car electric power 3 are disposed on the bottom face of the fixing base 1. A cavity 12 is formed between the barbs 11. A connection component 14 connected with the peripheral is disposed on a side face adjacent to the bottom face of the fixing base 1. In this embodiment, the peripheral can be an assembly of car audio loudspeakers 4, AM 5 and FM 6.

The DVD player 2 has a cover body 21 and a dock 22, which are pivotally connected together. The cover body 21 has a display 211 and loudspeakers 212. A connection port 23 connected with the connection component 14 of the fixing base 1 is disposed on a side face of the dock 22. Three embedding grooves 24 and a set of connectors 25 are disposed on the dock 22. A catch component 26 is disposed between the embedding grooves 24. A control component 27 is disposed in front of the catch component 26. The embedding grooves 24 correspond to the barbs 11 when the DVD player 2 and the fixing base 1 are engaged. The catch component 26 corresponds to the cavity 12. The connectors 25 contact the power connection portion 13. The connection port 23 connects the connection component 14.

When the DVD player 2 uses the embedding grooves 24 and the catch component 26 thereon to engage the barbs 11 and the cavity 12 of the fixing base 1, the connection port 23 of the DVD player 2 is connected with the connection component 14 of the fixing base 1, and the connectors 25 will contact the power connection portion 13 to let the power of the DVD player come from the car electric power 3. Signals of the peripheral are received from the DVD player 2.

The DVD player 2 can be taken out from the fixing base 1 through manipulation of the control component 27 (moved rightwards). Afterwards, the DVD player 2 can be used separately through the power from a battery base (not shown).

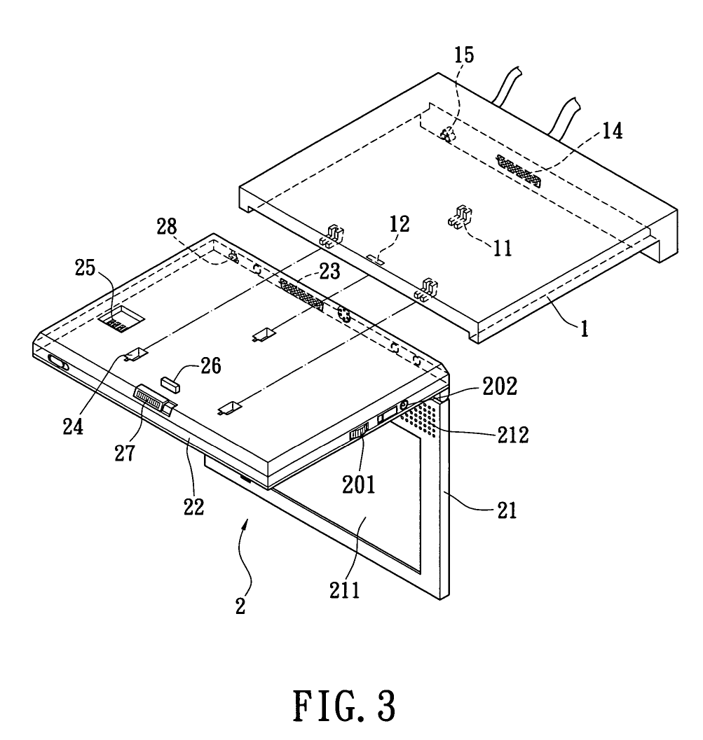

As shown in FIG. 3, the working power of the DVD player 2 of the present invention can also be acquired in another way. A connection point 28 is formed on a side face of the DVD player 2. A power connection pole 15 is projectively disposed on a side face of the fixing base 1. When the DVD player 2 uses the embedding grooves 24 and the catch component 26 thereon to engage the barbs 11 and the cavity 12 of the fixing base 1, the connection port 23 of the DVD player 2 can be connected with the connection component 14 corresponding to the fixing base 1, and the connection point 28 will contact the power connection pole 15 to let the power of the DVD player come from the car electric power 3.

The DVD player 2 can be taken out from the fixing base 1 through manipulation of the control component 27 (moved rightwards). Afterwards, the DVD player 2 can be used separately through the power from a battery base (not shown).

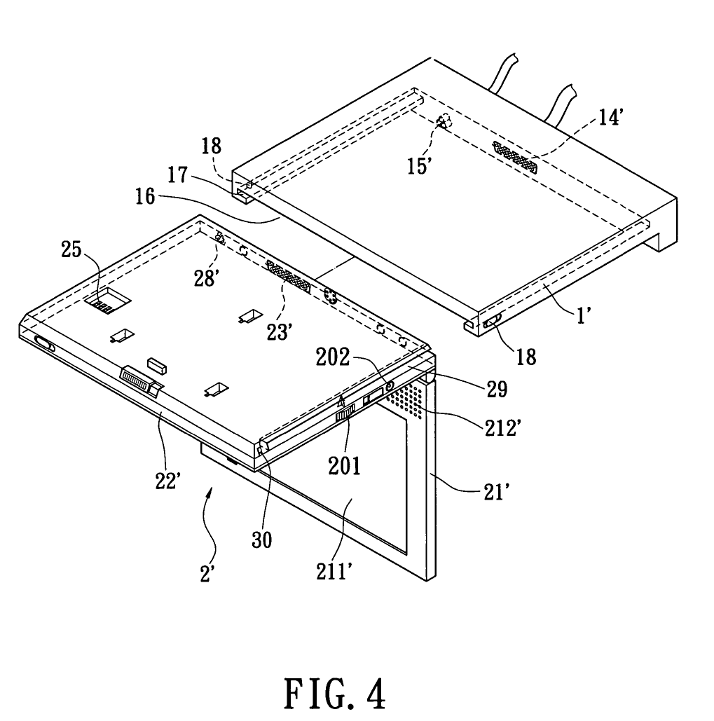

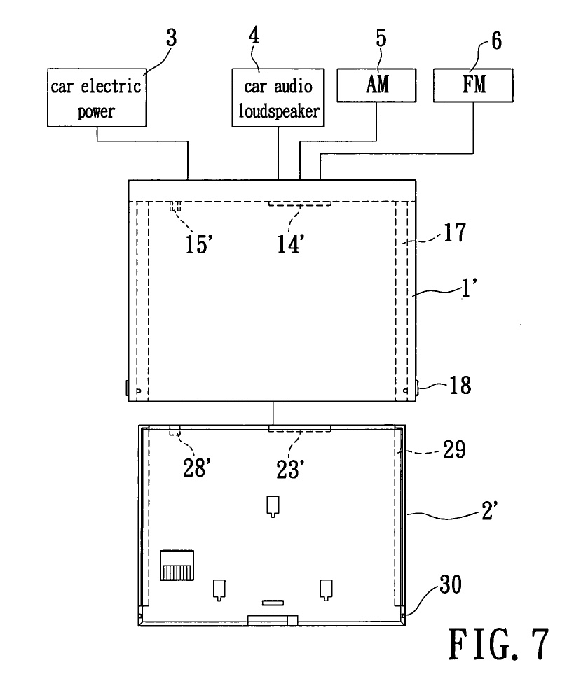

As shown in FIG. 4, an accommodation room 16 is disposed in the bottom face of the fixing base 1′. Guide grooves 17 are formed at two sides of the fixing base 1 for insertion of a DVD player 2′. A catch component 18 is disposed at one side at front edge of each of the guide grooves 17. A connection component 14′ connected with a peripheral and a power connection pole 15′ of the car electric power 3 are disposed on a side face adjacent to the guide grooves 17′ of the fixing base 1′. In this embodiment, the peripheral can be an assembly of loudspeakers 4, AM 5 and FM 6, as shown in FIG. 7.

The DVD player 2′ has a cover body 21′ and a dock 22′, which are pivotally connected together. The cover body 21′ has a display 211′ and loudspeakers 212′. A connection port 23′ and a connection point 28′ are disposed on a side face of the dock 22′. Sliding projective portions 29 are formed at two sides adjacent to the connection port 23′. A locking hole 30 is disposed in front of each of the sliding projective portions 29.

When the DVD player 2′ uses the sliding projective portions 29′ and the locking holes 30 thereon to engage the guide grooves 17 and the catch components 18 of the fixing base 1′, the connection port 23′ can be connected with the connection component 14′ corresponding to the fixing base 1′. The connection point 28′ contacts the power connection pole 15′ to let the power of the DVD player 2′ come from the car electric power 3. Signals of the peripheral are received from the DVD player 2′.

The DVD player 2′ can be taken out from the fixing base 1′ through manipulation of the catch components 18. Afterwards, the DVD player 2′ can be used separately through the power from a battery base (not shown).

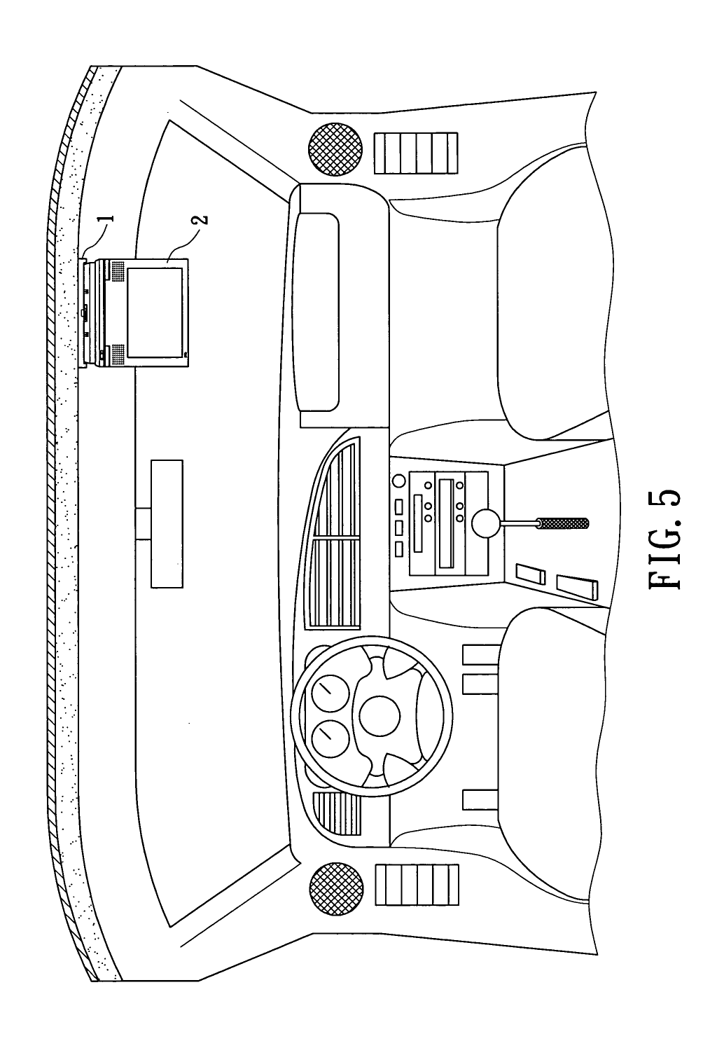

As shown in FIG. 5, the fixing base 1 is horizontally assembled (or hung) in a car. The power connection portion 13 (or the power connection pole 15, 15′) and the connection component 14 (14′) of the fixing base 1 (1′) are connected with the car electric power 3 and the peripheral, respectively. When the DVD player 2 and the fixing base 1 are assembled together, a user can select contents to be played through manipulation of the DVD player 2.

Moreover, a volume adjust component 201 and an earphone socket 202 are disposed on a side face of the dock 22 (or 22′) of the DVD player 2 (or 2′).

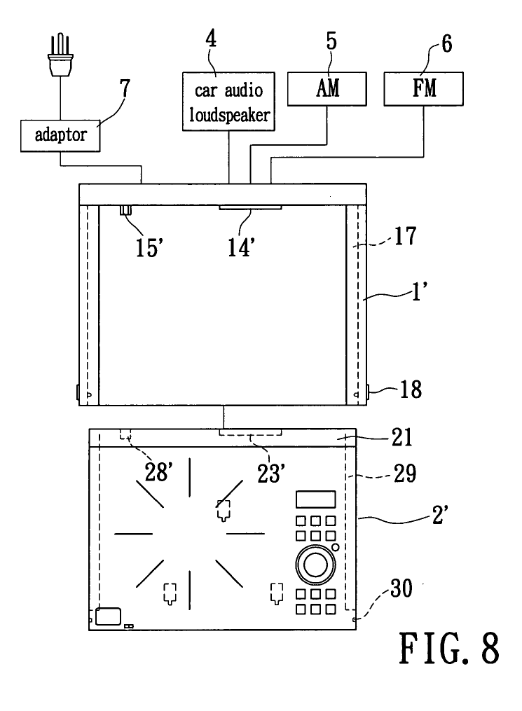

As shown in FIG. 8, when the present invention is applied indoors (e.g., in an apartment), the power of the fixing base 1′ having the functions of a peripheral directly comes from a DC power outputted by an adaptor 7. When the DVD player 2′ and the fixing base 1′ are assembled together, a user can select contents to be played through manipulation of the DVD player 2′.

Besides, in addition to embedding and slots, the DVD player 2 (or 2′) of the present invention can also be combined with the fixing base 1 (or 1′) by means of rollers, slide tracks or in a hydraulic way.

To sum up, the present invention has the following characteristics:
1. A portable DVD player and a fixing base having the functions of a peripheral can be combined together by means of slots or embedding mechanism to form a multifunction DVD player.
2. For consumers, there is another choice, and the purchase cost can be lowered.
3. The present invention can be applied indoors and outdoors.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A multifunction digital versatile disc (DVD) expansion playback device comprising:
a fixing base having functions of a peripheral; and
a portable DVD player;
whereby signals of said peripheral are received from said DVD player when said DVD player and said fixing base are combined together, and said DVD player is also able to be taken out from said fixing base.

2. The multifunction DVD expansion playback device as claimed in claim 1, wherein said peripheral is an assembly of an amplitude modulator (AM), frequency modulator (FM) or car audio loudspeakers.

3. The multifunction DVD expansion playback device as claimed in claim 1, wherein the power of said DVD player comes from a car electric power or an external direct current (DC) power.

4. A multifunction DVD expansion playback device comprising:
a fixing base having functions of a peripheral, several barbs and a power connection portion of an external DC power being projectively disposed on a bottom face of said fixing base, a cavity being formed on the bottom face of said fixing base, a connection component connected with said peripheral being disposed on a side face adjacent to the bottom face of said fixing base; and
a portable DVD player having a dock, a connection port being disposed on a side face of said dock, said dock having several embedding grooves, a set of connectors, a catch component and a control component;
whereby when said DVD player uses said embedding grooves and said catch component thereon to engage said barbs and said cavity of said fixing base, said connection port is connected with said connection component of said fixing base, and said connectors contact said power connection portion to let power of said DVD player come from said external DC power, and signals of said peripheral are received from said DVD player, or said DVD player is able to be taken out from said fixing base through manipulation of said control component.

5. The multifunction DVD expansion playback device as claimed in claim 4, wherein a volume adjust component and an earphone socket are disposed on said dock of said DVD player.

6. The multifunction DVD expansion playback device as claimed in claim 4, wherein said peripheral is an assembly of AM, FM or car audio loudspeakers.

7. A multifunction DVD expansion playback device comprising:
a fixing base having the functions of a peripheral, several barbs being projectively disposed on a bottom face of said fixing base, a cavity being formed on the bottom face, a connection component connected with said peripheral and a power connection pole of an external DC power being disposed on a side face adjacent to the bottom face of said fixing base; and
a portable DVD player having a dock, a connection port and a connection point being disposed on a side face of said dock, said dock having several embedding grooves, a catch component and a control component;
whereby when said DVD player uses said embedding grooves and said catch component thereon to engage said barbs and said cavity of said fixing base, said connection port is connected with said connection component of said fixing base, said connection point contacts said power connection pole to let power of said DVD player come from said external DC power, and signals of said peripheral are received from said DVD player, or said DVD player is able to be taken out from said fixing base through manipulation of said control component.

8. The multifunction DVD expansion playback device as claimed in claim 7, wherein a volume adjust component and an earphone socket is disposed on said dock of said DVD player.

9. The multifunction DVD expansion playback device as claimed in claim 7, wherein said peripheral is an assembly of AM, FM or car audio loudspeakers.

10. A multifunction DVD expansion playback device comprising:
a fixing base having the functions of a peripheral, an accommodation room being formed on a bottom face of said fixing base, guide grooves being formed at two sides of said fixing base, a catch component being disposed at one side of each of said guide grooves, a connection component connected with said peripheral and a power connection pole of an external DC power being disposed on a side face adjacent to said guide grooves of said fixing base; and
a portable DVD player having a dock, a connection port and a connection point being disposed on a side face of said dock, sliding projective portions and locking holes being formed on two sides adjacent to said connection port;
whereby when said DVD player uses said sliding projective portions and said locking holes thereon to engage said guide grooves and said catch components of said fixing base, said connection port is connected with said connection component of said fixing base, said connection point contacts said power connection pole to let power of said DVD player come from said external DC power, and signals of said peripheral are received from said DVD player, or said DVD player is able to be taken out from said fixing base through manipulation of said catch components.

11. The multifunction DVD expansion playback device as claimed in claim 10, wherein a volume adjust component and an earphone socket is disposed on said dock of said DVD player.

12. The multifunction DVD expansion playback device as claimed in claim 10, wherein said peripheral is an assembly of AM, FM or car audio loudspeakers.
